(19) United States
(12) Patent Application Publication
(10) Pub. No.: US 2011/0192294 A1
(43) Pub. Date: Aug. 11, 2011

(54) EZ-CRUSH

(76) Inventor: Christopher Salisbury, Laguna Hills, CA (US)

(21) Appl. No.: 13/020,810

(22) Filed: Feb. 4, 2011

Related U.S. Application Data
(60) Provisional application No. 61/303,016, filed on Feb. 10, 2010.

(51) Int. Cl. B30B 9/32; B30B 1/18; B30B 15/14

(52) U.S. Cl. 100/345; 100/245; 100/131

(57) ABSTRACT

A beverage container crushing appliance which increases individual's efficiency in storing and transporting recyclables. The appliance quickly compacts/compresses aluminum cans and plastic bottles down to about one tenth of their original size. The beverage container crushing appliance comprises a housing having an internal liner; a sliding door; an electric motor; a gear set; a plunger; and an electric power communicator cord. The sliding door is slidably manipulatable between open and closed conditions to provide access to the internal liner for placement or removal of beverage containers. The electric motor is in electrical communication with a power source via the electric power communicator cord and when activated, causes rotation of the gear set causing the plunger to move in either a downward-crush motion thereby compressing the beverage container or in an upward non-crush motion allowing a user to remove the beverage container for recycling.

### CROSS-REFERENCE TO RELATED APPLICATION

The present application is related to and claims priority from prior provisional application Ser. No. 61/303,016, filed Feb. 10, 2010 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

The following includes information that may be useful in understanding the present invention(s). It is not an admission that any of the information provided herein is prior art, or material, to the presently described or claimed inventions, or that any publication or document that is specifically or implicitly referenced is prior art.

### BACKGROUND OF THE INVENTION

1. Field of the Invention

The present invention relates generally to the field of appliances and more specifically relates to a beverage container crushing appliance for crushing recyclable beverage containers into a compact volume for efficient storage and transport.

2. Description of the Related Art

Beverages are often contained within cans or bottles for human consumption. Beverage cans may be made of tin-plated steel or aluminum which may be recycled for future uses. Crushers may be used for crushing metal products in junkyards and for other applications. Modernly, the cost of materials and concern for the environment has induced many individuals within our society to recycle. Recycling may be inconvenient because of the storage space required for such activities. A can crusher is needed to provide extra space by flattening either single or multiple cans.

In spite of the environmental and financial incentives for recycling, many individuals and businesses do not recycle their cans and bottles simply because of the inconvenience of having to make multiple trips to the recycling center. Non-compacted cans and bottles can quickly fill a trash bag, and trash bags full of recyclables can quickly fill a small car. Many states offer a cash reimbursement for cans and bottles so the more items an individual can drop off at a time, the more cost-effective the trip will be. Therefore a need exists for a safe and easy-to-use beverage container crushing appliance that aids in this process.

Various attempts have been made to solve the above-mentioned problems such as those found in U.S. Pat. Nos. 5,967,029; 4,570,536; 4,771,685; 4,667,593; 4,550,658; and 4,962,701. This prior art is representative of can crushers. None of the above inventions and patents, taken either singly or in combination, is seen to describe the invention as claimed.

Ideally, a can crusher should be user-friendly and, yet would operate reliably and be manufactured at a modest expense. Thus, a need exists for a reliable easy crush and save system for crushing beverages into a compact volume for easier storage and transport for recycling and to avoid the above-mentioned problems.

### BRIEF SUMMARY OF THE INVENTION

In view of the foregoing disadvantages inherent in the known crusher art, the present invention provides a novel easy crush and save system, “EZ-Crush”. The general purpose of the present invention, which will be described subsequently in greater detail is to provide a beverage container crushing appliance that makes it easier for individuals to store and transport recyclables. This beverage container crushing appliance quickly compresses aluminum cans and plastic bottles down to about one tenth of their original size.

The beverage container crushing appliance described herein is preferably washable, and dis-assemblable and may comprise: a dome-shaped cylinder housing having an internal liner; a sliding door; an electric motor; a gear set; an electric power communicator cord; a first bottom-removable tray; a second bottom-removable tray; and an on/off switch.

The sliding door is slidably manipulatable between open and closed conditions in the dome-shaped cylinder housing to provide access to the internal liner for placement or removal of at least one beverage container (after being crushed). The sliding door, when open prevents the activation of the plunger. Further, when the sliding door is closed, the sliding door allows the activation of the plunger.

The gear set for use in mechanically moving the plunger may comprise a drive sprocket, at least a first rotatable gear, at least a second rotatable gear, at least a third rotatable gear, and at least a fourth rotatable gear. The drive sprocket is rotated via the electric motor causing the first rotatable gear, the second rotatable gear, the third rotatable gear, and the fourth rotatable gear to operate the plunger for can crushing operations.

The electric motor is in electrical communication with a power source via the electric power communicator cord. Further, when the electric motor is activated, the electric motor causes rotation of the gear set by rotating the first rotatable gear, in relation to the second rotatable gear, the third rotatable gear, and the fourth rotatable gear causing the plunger to move in either a downward-crush motion thereby compressing the beverage container or in an upward non-crush motion allowing a user to remove the beverage container for recycling. The plunger may comprise a planar metal plate (substantially flat so the cans when crushed have a flat profile) having a mass of about 3 lbs, four threaded plunger rods, and a circular cross-section. The second bottom-removable tray comprises a liquid holding inner volume for catching at least one fluid from the beverage container, and a Y-shaped clamp allows the user to remove the second bottom-removable tray to empty the at least one fluid from the beverage container. The on/off switch controls power to the beverage container crushing appliance.

In accordance with the embodiments of the present invention a preferred method of use is disclosed herein comprising: step one plugging an electric power communicator cord into an outlet (if unplugged); step two opening a sliding door in a dome-shaped cylinder housing; step three placing a beverage container upside down inside an internal liner of the dome-shaped cylinder housing; step four closing the sliding door in the dome-shaped cylinder housing; and step five pushing On/off switch control located on the a dome-shaped cylinder housing to activate crushing. The device may be used until all the cans/bottles are crushed then stored for future use after being cleaned.

The present invention holds significant improvements and serves as an easy crush and save system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, EZ-Crush, constructed and operative according to the teachings of the present invention.

FIG. 1 is a perspective view illustrating a beverage container crushing appliance of an easy crush and save system in an in-use condition according to an embodiment of the present invention.

FIG. 2 is a perspective view illustrating the beverage container crushing appliance according to an embodiment of the present invention of FIG. 1.

FIG. 3 is a perspective view illustrating the beverage container crushing appliance according to an embodiment of the present invention of FIG. 1.

FIG. 4 shows perspective views illustrating the beverage container crushing appliance according to an embodiment of the present invention of FIG. 1.

FIG. 5 is an exploded view of the beverage container crushing appliance according to an embodiment of the present invention of FIGS. 1-4.

The various embodiments of the present invention will hereinafter be described in conjunction with the appended drawings, wherein like designations denote like elements.

### DETAILED DESCRIPTION

As discussed above, embodiments of the present invention relate to a beverage container crushing appliance and more particularly to easy crush and save system, EZ-Crush, for crushing beverages into a compact volume for easier storage and transport for recycling activities.

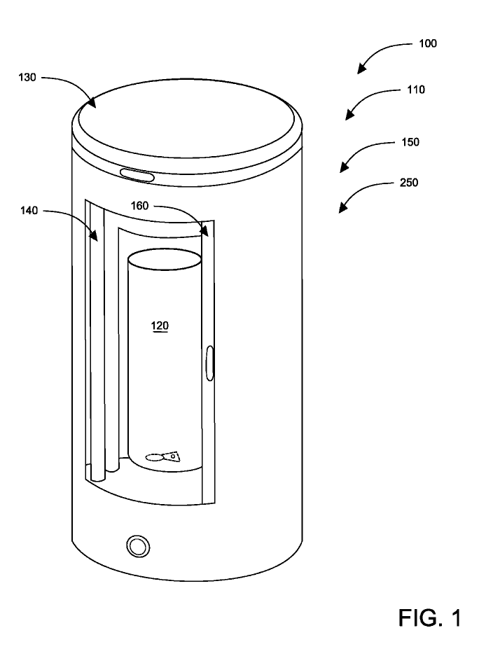

Referring to the drawings by numerals of reference there is shown in FIG. 1 is a perspective view illustrating beverage container crushing appliance 110 of easy crush and save system 100 in an in-use condition 150 according to an embodiment of the present invention.

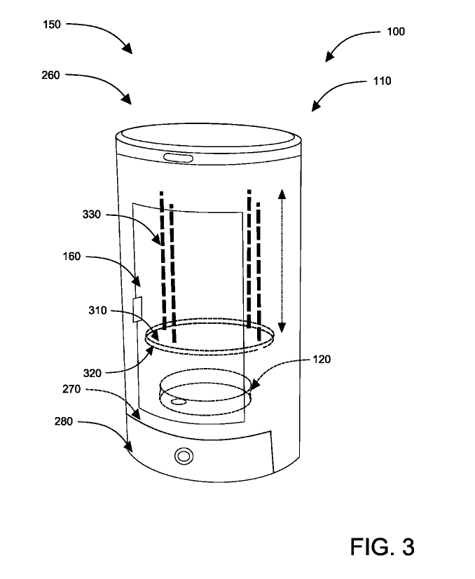

Easy crush and save system 100 preferably comprises beverage container crushing appliance 110 for crushing beverage containers 120 into suitably compressed profiles (shown in FIG. 3) designed for space-saving within storage containers. Beverage container crushing appliance 110 preferably comprises: a dome-shaped cylinder housing 130 (or non-dome-shaped) having internal liner 140; at least one sliding door 160; at least one electric motor 170; and at least one gear set 180.

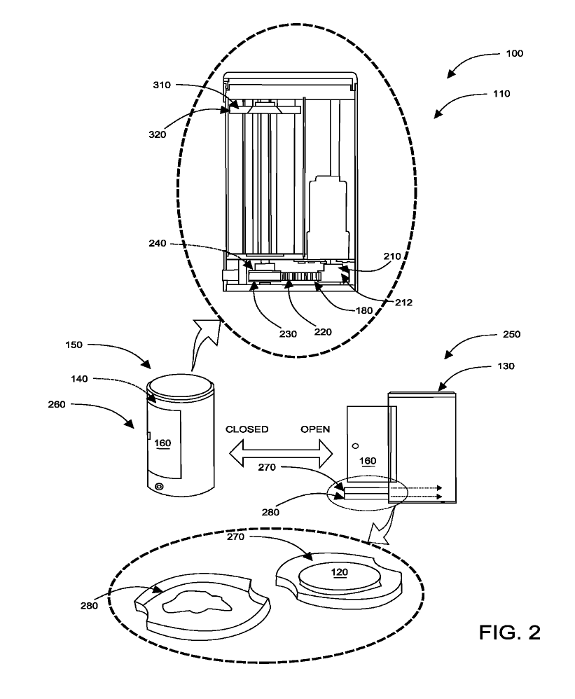

Gear set 180, as alluded to in FIGS. 2 & 5 comprises at least a first rotatable gear 210, at least a second rotatable gear 220, at least a third rotatable gear 230, and at least a fourth rotatable gear 240; plunger 310 (best viewed in FIG. 3); and an electric power communicator cord connectable to an AC outlet. Upon reading this specification, it should be appreciated that, under appropriate circumstances, considering such issues as user preferences, design preference, structural requirements, marketing preferences, cost, available materials, technological advances, etc., other crushing arrangements and means such as, for example, different gear sets/combinations, screws, pneumatic or hydraulic powering means, etc., may be sufficient. Further, DC powering means may also be employed in certain embodiments. Further, gear set 180 may comprise more or less gears and may also be driven by a toothed belt.

Sliding door 160 is slidably manipulatable between open and closed conditions (open condition 250 and closed condition 260, respectively), as shown in FIG. 2 within dome-shaped cylinder housing 130 to provide access to internal liner 140 for placement or removal of at least one beverage container 120. It should be appreciated that beverage containers 120 may comprise cans and/or bottles or other recyclable items/objects. As a safety feature in-use condition 150 comprises closed condition 260 in the present invention such that a user's hands and fingers are effectively protected from potential damage (pinching/crushing/cutting). In this way the present invention provides safety for its users in a passive manner. In this way sliding door 160, when open prevents the activation of plunger 310 and sliding door 160, when closed allows the activation of plunger 310. In certain embodiments this particular safety feature may be embodied via a safety switch or relay that restricts movement of gear set 180 when beverage container crushing appliance 110 is in open condition 250. The device may comprise an up/down switch to manipulate which direction plunger 310 is operated in.

Referring now to powering means: electric motor 170 is preferably in electrical communication with an AC power source via electric power communicator cord as mentioned previously. Gear set 180, when activated, causes direct or indirect rotation of gear set 180 by rotating (drive sprocket 212—discussed subsequently) and/or first rotatable gear 210, operatively connected in relation (when in direct contact) to second rotatable gear 220, third rotatable gear 230, and fourth rotatable gear 240 causing plunger 310 to move in either a downward-crush motion thereby compressing beverage container 120 or in an upward non-crush motion (as shown in FIG. 3) allowing a user to remove beverage container 120 for recycling. In alternate embodiments gear set 180 and/or electric motor 170 may be otherwise operatively connected in indirect relation to one another to provide rotating means for first rotatable gear 210, second rotatable gear 220, third rotatable gear 230, and/or fourth rotatable gear 240. Connecting means may comprise toothed shafts, meshed gears of various types including internal gears, spur gears, helical, double-helical, bevel, worm, rack and pinion, sun and planet, hypoids, and other suitable equivalents which may be used for transmitting rotational motion communicating transmitted torque from electric motor 170 sufficient to mechanically operate plunger 310 alternately between downward-crushing and upward-release motions. It should also be appreciated that the desired mechanical advantage may be achieved through gear ratio selection of gear set 180 and that various sizes of first rotatable gear 210, second rotatable gear 220, third rotatable gear 230, and/or fourth rotatable gears 240 may be used to attain the desired torque, speed of motion etc, as per user-preference.

It is also desirable that beverage container crushing appliance 110 is portable such that beverage container crushing appliance 110 is removably mountable on a countertop such as in a kitchen or the like (larger versions may be available and may be used in airplanes, boats, trains, hotel/motel, restaurant/bars and other suitable locations). In preferred embodiments of beverage container crushing appliance 110 comprises an on/off switch to activate or deactivate beverage container crushing appliance 110.

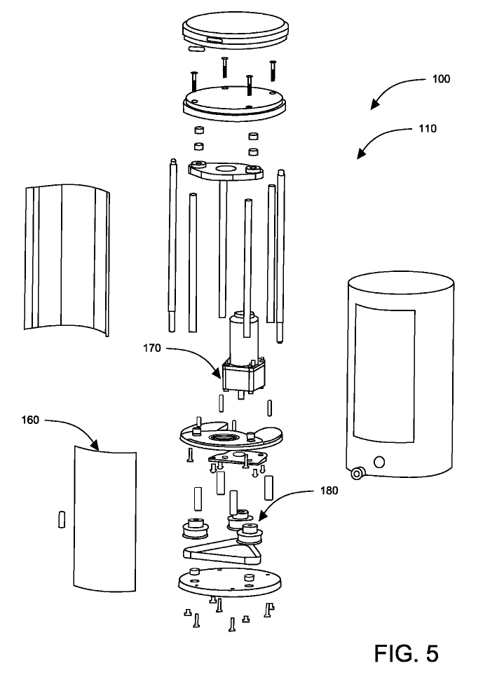

Referring now to FIG. 2, a perspective view illustrating beverage container crushing appliance 110 according to an embodiment of the present invention of FIG. 1. (FIG. 5 showing an exploded view of the present figure.)

As related to the options for gear set 180 described above, the present invention may also be enabled using gear set 180 further comprising at least one drive sprocket 212. In this particular version drive sprocket 212 is rotated via electric motor 170 causing first rotatable gear 210, second rotatable gear 220, third rotatable gear 230, and fourth rotatable gear 240 to operate plunger 310 creating an ‘evenly distributed push’. As mentioned previously it is preferable that uncrushed beverage container 120 be inserted for crushing into beverage container crushing appliance 110 while sliding door 160 is in open condition 250. Next, sliding door 160 is closed (slidably, rotatably or other) to form closed condition 260 to perform crushing action during in-use condition 150 using plunger 310. Crushing action may comprises the convenient crushing of one beverage container 120 at a time such that the device is handy for use in non-commercial and/or commercial applications.

The present FIG. 2 shows beverage container crushing appliance 110 in a shrouded and unshrouded profile illustrating safety and aesthetic features of dome-shaped cylinder housing 130. Safety features may comprise protection for users from rotating from gear set 180 as well as substantially preventing dust, debris and liquid contaminants from entering and deteriorating gear set 180. In certain embodiments dome-shaped cylinder housing 130 comprises stainless steel or colored surfaces such as black, white, silver or the like to match the user's kitchen decor. It should be appreciated that the device may comprise various materials and/or colors as per manufacturer/user-preference.

Plunger 310 may comprise planar metal plate 320. Plunger 310 comprises a plurality of threaded or unthreaded plunger rods 330. Within the embodiment shown in FIG. 3 there are four plunger rods 330.

Referring now to FIG. 3, showing a perspective view illustrating beverage container crushing appliance 110 according to an embodiment of the present invention of FIG. 1.

Another novel feature of the present invention (also shown in FIG. 2) is first bottom-removable tray 270. First bottom-removable tray 270 may comprise a recess for contact-receiving beverage container 120. Certain embodiments further comprise second bottom-removable tray 280. Other embodiments may comprise no tray(s). Second bottom-removable tray 280 comprises a liquid holding inner volume for catching and retaining at least one fluid from beverage container 120. Second bottom-removable tray 280 may comprise a Y-shaped clamp (or other shape or no clamp) allowing a user to remove second bottom-removable tray 280 to empty at least one fluid from beverage container 120. In this way using the present invention the user is able to remove and empty second bottom-removable tray 280 to minimize liquid spillage thereby avoiding a sticky mess.

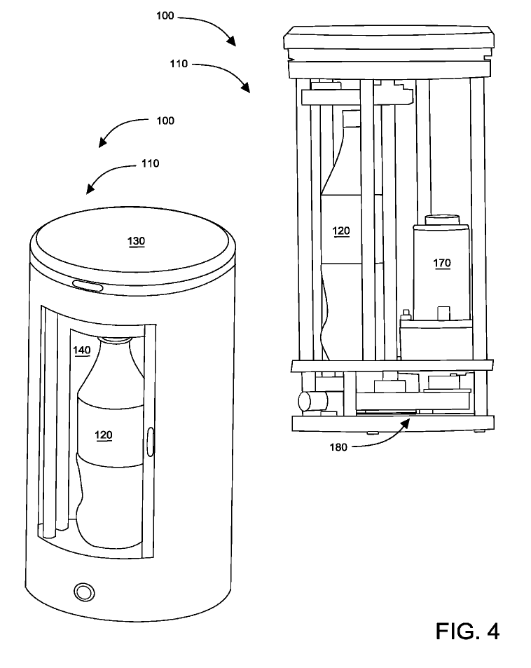

Referring now to FIGS. 4 and 5, showing perspective views in FIG. 4 and an exploded view in FIG. 5 illustrating beverage container crushing appliance 110 according to an embodiment of the present invention of FIGS. 1-4.

Referring now back to planar metal plate 320 preferably comprising a circular cross-section, as shown in FIG. 3, planar metal plate 320 may comprise a mass of about 3 lbs, sufficient to crush beverage container 120 manufactured of aluminum or other recyclable material(s). Planar metal plate 320 may comprise an aperture such that a bottleneck may be held during crushing operations. Beverage container crushing appliance 110 is dis-assemblable and is washable to remove residue liquid from crushing operations during in-use condition 150. Additionally, FIG. 5 is used to show the relationship between the various components in beverage container crushing appliance 110; however it should be appreciated that other suitable equivalents may be employed to achieve a substantially similar structure and/or functionality.

A method of using beverage container crushing appliance 110 may comprise the steps of: plugging an electric power communicator cord into an AC outlet, opening sliding door 160 in dome-shaped cylinder housing 130 (or non-domed shaped), placing beverage container 120 preferably upside down (to drain remaining beverage)—(or alternately right-side-up) inside internal liner 140 of dome-shaped cylinder housing 130; slidingly closing or otherwise closing sliding door 160 in dome-shaped cylinder housing 130; and activating On/off switch control (up/down) located on dome-shaped cylinder housing 130 to crush beverage container 120. Next beverage container 120 may be removed after sliding door 160 is opened. Beverage container crushing appliance 110 may be stored, when cleaned for the next use. It should be noted that the steps described in the method of use can be carried out in many different orders according to user preference. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient. Further, in certain embodiments the present invention may be solar powered.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A beverage container crushing appliance comprising:
a housing having an internal liner;
a sliding door;
an electric motor;
a gear set comprising at least a first rotatable gear, at least a second rotatable gear, at least a third rotatable gear, and at least a fourth rotatable gear;
a plunger; and
an electric power communicator cord;
wherein said sliding door is slidably manipulatable between open and closed conditions in said housing to provide access to said internal liner for placement and/or removal of at least one beverage container;
wherein said electric motor is in electrical communication with a power source via said electric power communicator cord;
wherein said electric motor, when activated, causes rotation of said gear set by rotating said first rotatable gear, operatively connected in relation to said second rotatable gear, said third rotatable gear, and said fourth rotatable gear causing said plunger to move in either a downward-crush motion thereby compressing said beverage container or in an upward non-crush motion allowing a user to remove said beverage container for recycling; and
wherein said beverage container crushing appliance is portable.

2. The beverage container crushing appliance of claim 1 wherein said gear set further comprises a drive sprocket.

3. The beverage container crushing appliance of claim 1 wherein said drive sprocket is rotated via said electric motor causing said first rotatable gear, said second rotatable gear, said third rotatable gear, and said fourth rotatable gear to operate said plunger.

4. The beverage container crushing appliance of claim 3 wherein said plunger comprises a planar metal plate.

5. The beverage container crushing appliance of claim 4 wherein said plunger comprises at least one threaded plunger rod.

6. The beverage container crushing appliance of claim 4 wherein said plunger comprises four of said threaded plunger rods.

7. The beverage container crushing appliance of claim 1 further comprising a first bottom-removable tray.

8. The beverage container crushing appliance of claim 1 further comprising a second bottom-removable tray.

9. The beverage container crushing appliance of claim 8 wherein said second bottom-removable tray comprises a liquid holding inner volume for catching at least one fluid from said beverage container.

10. The beverage container crushing appliance of claim 9 wherein said second bottom-removable tray comprise a Y-shaped clamp allowing said user to remove said second bottom-removable tray to empty said at least one fluid from said beverage container.

11. The beverage container crushing appliance of claim 1 further comprising an on/off and/or up/down switch.

12. The beverage container crushing appliance of claim 4 wherein said planar metal plate comprises a circular cross-section.

13. The beverage container crushing appliance of claim 12 wherein said planar metal plate comprises a mass of about 3 lbs.

14. The beverage container crushing appliance of claim 1 wherein said sliding door, when open prevents the activation of said plunger.

15. The beverage container crushing appliance of claim 1 wherein said sliding door, when closed allows the activation of said plunger.

16. The beverage container crushing appliance of claim 7 wherein said first bottom-removable tray comprises a recess for contact-receiving said beverage container.

17. The beverage container crushing appliance of claim 1 wherein said housing comprises stainless steel.

18. The beverage container crushing appliance of claim 1 wherein said beverage container crushing appliance is dis-assemblable.

19. The beverage container crushing appliance of claim 18 wherein said beverage container crushing appliance is washable.

20. A washable, dis-assemblable beverage container crushing appliance comprising:
a stainless steel dome-shaped cylinder housing having an internal liner;
a sliding door;
an electric motor;
a drive sprocket comprising at least a first rotatable gear, at least a second rotatable gear, at least a third rotatable gear, and at least a fourth rotatable gear;
a plunger comprising a planar metal plate having a mass of about 3 lbs, four threaded plunger rods, said planar metal plate having a circular cross-section;
an electric power communicator cord;
a first bottom-removable tray having a recess for contact-receiving beverage container(s);
a second bottom-removable tray having a liquid holding inner volume for catching at least one fluid from said beverage container, and a Y-shaped clamp allowing said user to remove said second bottom-removable tray to empty said at least one fluid from said beverage container; and
an on/off switch;
wherein said sliding door is slidably manipulatable between open and closed conditions in said dome-shaped cylinder housing to provide access to said internal liner for placement or removal of at least one beverage container;
wherein said sliding door, when open prevents activation of said plunger and when closed allows the activation of said plunger;
wherein said electric motor is in electrical communication with an AC power source via said electric power communicator cord; and
wherein said electric motor, when activated, causes rotation of said gear set by rotating said first rotatable gear, in relation to said second rotatable gear, said third rotatable gear, and said fourth rotatable gear causing said plunger to move in either a downward-crush motion thereby compressing said beverage container or in an upward non-crush motion allowing a user to remove said beverage container for recycling;
wherein said drive sprocket is rotated via said electric motor causing said first rotatable gear, said second rotatable gear, said third rotatable gear, and said fourth rotatable gear to operate said plunger; and
wherein said on/off switch controls power to washable, dis-assemblable beverage container crushing appliance.
